(19) United States
(12) Patent Application Publication
(10) Pub. No.: US 2024/0347285 A1
(43) Pub. Date: Oct. 17, 2024

(54) SWITCH

(71) Applicant: MITSUBISHI HEAVY INDUSTRIES THERMAL SYSTEMS, LTD., Tokyo (JP)

(72) Inventors: Yasuo KATAYAMA, Tokyo (JP); Koichi KAWABATA, Aichi (JP); Yuya NAGAI, Aichi (JP)

(73) Assignee: MITSUBISHI HEAVY INDUSTRIES THERMAL SYSTEMS, LTD., Tokyo (JP)

(21) Appl. No.: 18/294,855

(22) PCT Filed: Jun. 8, 2022
(86) PCT No.: PCT/JP2022/023170

§ 371 Date: Feb. 2, 2024

(30) Foreign Application Priority Data
Aug. 4, 2021 (JP) 2021-127951

(51) Int. Cl. H01H 3/04; H01H 9/02

(52) U.S. Cl. CPC H01H 3/04; H01H 9/02; H01H 2215/03

(57) ABSTRACT

Provided is a switch which achieves cost reduction and reduction in man-hours required for assembly. This switch comprises: a casing having a wall portion; two rubber domes that are provided to face each other with the wall portion sandwiched therebetween and give a click feeling; a lever main body having a retaining portion that is provided to be rotatable about an axis X with respect to the casing and retains the rubber domes and a contact portion that is in contact with a detector switch. The inside surface of the retaining portion is formed into an arch shape with the wall portion put therein, the two rubber domes are provided integrally with an elastic sheet member, and the sheet member is bent along the arch shape of the inside surface and retained by the retaining portion.

### TECHNICAL FIELD

The present disclosure relates to a switch suitable for use in an air-conditioning device.

### BACKGROUND ART

In a switch in which a detector switch is indirectly turned on and off by operation of a lever, a rubber dome may be provided to give a click feeling (moderate operation feeling) to a user who operates the lever (for example, Patent Document 1).

### CITATION LIST

### Patent Literature

Patent Document 1: JP 6294290 B

### SUMMARY OF INVENTION

### Technical Problem

In the configuration described in Patent Document 1, a holder for holding the rubber dome and a body are provided as separate components.

However, when the holder and the body are separate components, not only the number of components increases causing increase in cost, but also the number of steps required for assembling the switch increases.

The present disclosure has been made in view of such circumstances, and an object thereof is to provide a switch that can achieve cost reduction and reduction in man-hours required for assembly.

### Solution to Problem

In order to solve the problem described above, a switch of the present disclosure adopts the following means.

That is, a switch according to an aspect of the present disclosure includes: a casing including a wall portion: two clicking members that are provided so as to oppose to each other across the wall portion and give a click feeling: a lever main body including a retaining portion and a contact portion, the retaining portion being provided to be rotatable about an axis with respect to the casing and configured to retain the clicking members, the contact portion being configured to come into contact with a detector switch.

### Advantageous Effects of Invention

According to the present disclosure, it is possible to achieve cost reduction and reduction in man-hours required for assembly.

### BRIEF DESCRIPTION OF DRAWINGS

FIG. 1 is a perspective view of a switch according to an embodiment of the present disclosure.

FIG. 2 is a perspective view of a lever according to the embodiment of the present disclosure.

FIG. 3 is a perspective view of a rubber sheet.

FIG. 4 is a perspective view of the rubber sheet bent into a U-shape.

### DESCRIPTION OF EMBODIMENTS

A switch according to an embodiment of the present disclosure will be described below with reference to the drawings.

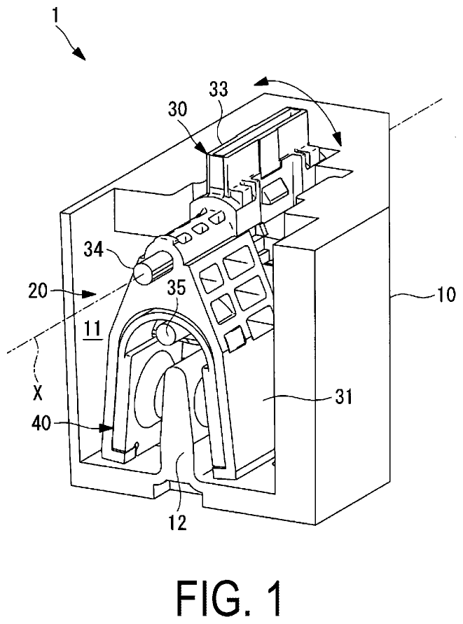

As illustrated in FIG. 1, a switch 1 includes a casing 10 and a lever 20.

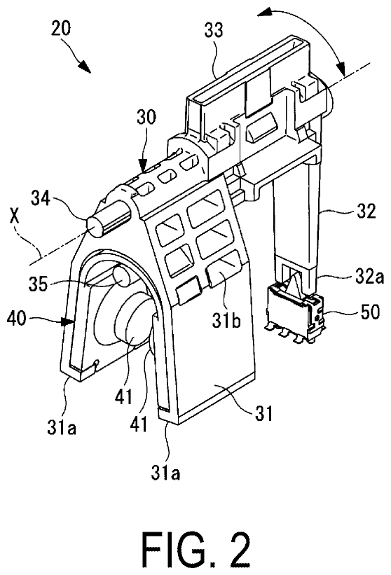

The casing 10 defines an accommodating space 11 that accommodates the lever 20 and a detector switch 50 (see FIG. 2).

The casing 10 is formed with a wall portion 12 that protrudes in a predetermined direction (upward direction in the same drawing) from a bottom surface in the accommodating space 11.

As illustrated in FIGS. 1 and 2, the lever 20 includes a lever main body 30 and a rubber sheet (sheet member) 40.

The lever main body 30 includes a retaining portion 31, a contact portion 32, and an operation portion 33 which rotate about a shaft portion 34 along an axis X. The retaining portion 31, the contact portion 32, the operation portion 33, and the shaft portion 34 are integrally formed of resin.

The lever main body 30 is pivotally supported by the shaft portion 34 so as to be rotatable about the axis X with respect to the casing 10.

The retaining portion 31 is an inverted U-shape portion including two leading ends 31a and extends from the shaft portion 34 in a predetermined direction (downward direction in the same drawings).

The rubber sheet 40 to be described below is retained by an arch-shaped inside surface of the retaining portion 31.

As illustrated in FIG. 1, the leading ends 31a of the retaining portion 31 oppose to each other across the wall portion 12 formed at the casing 10.

The contact portion 32 is a portion including bifurcated leading ends 32a and extends from the shaft portion 34 in the same direction as the extending direction of the retaining portion 31. Further, the contact portion 32 is offset from the retaining portion 31 in a direction of the axis X such that a gap is provided between the contact portion 32 and the retaining portion 31.

The leading ends 32a of the contact portion 32 come into contact with the detector switch 50.

The operation portion 33 is a portion that is moved when a user operates the lever 20 and extends from the shaft portion 34 in a direction opposite to the extending direction of the retaining portion 31 and the contact portion 32 (upward direction in the same drawings) so as to protrude from the casing 10. Further, the operation portion 33 is offset from the retaining portion 31 in the direction of the axis X and is located approximately between the retaining portion 31 and the contact portion 32. That is, the operation portion 33 is provided on a side opposite to the gap provided between the retaining portion 31 and the contact portion 32 with respect to the axis X.

With this configuration, by providing a light source in the gap provided between the retaining portion 31 and the contact portion 32, a visual effect using the light source can be given to the operation portion 33.

A design grip (not illustrated) is provided at an upper part of the operation portion 33, so that a user moves the operation portion 33 via the design grip. When the user moves the operation portion 33 about the shaft portion 34 (axis X) via the design grip, the entire lever 20 rotates about the shaft portion 34 (axis X).

As illustrated in FIG. 2, the lever main body 30 (for example, the retaining portion 31) may be provided with lightening portions 31b.

With this configuration, the resin is uniformly cooled at the time of molding the lever main body 30, and thus the occurrence of molding defects such as sink marks can be suppressed. In addition, by providing the lightening portions 31b, a rib is formed between the lightening portions 31b adjacent to each other, which can increase the strength of the lever main body 30.

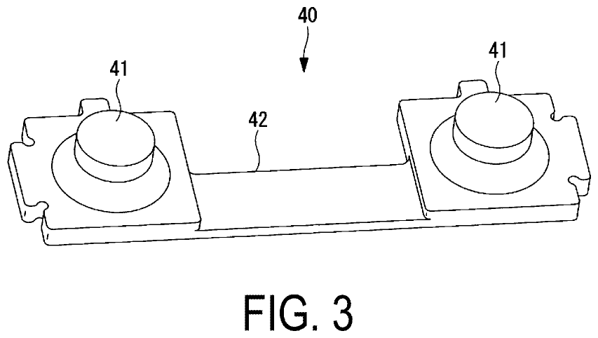

As illustrated in FIG. 3, the rubber sheet 40 is an elastic body having flexibility and includes two rubber domes (clicking members) 41 and a connection portion 42 that connects the rubber domes 41. The rubber domes 41 and the connection portion 42 are integrally formed of, for example, silicone.

The rubber dome 41 is a portion that is elastically deformed when subjected a load applied and exerts a repulsive force against the load and has a shape protruding in a bowl shape.

The rubber dome 41 is a member for giving a click feeling (moderate operation feeling and moderate repulsive force) to a user who operates the lever 20.

The two rubber domes 41 are disposed so as to be spaced apart from each other, and the rubber domes 41 spaced apart from each other are connected by the connecting portion 42 having a sheet shape.

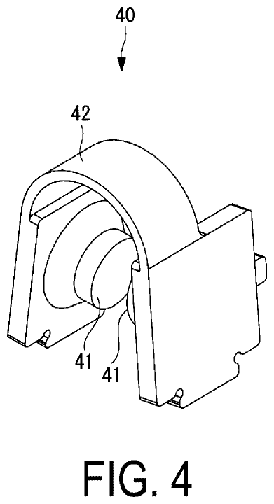

The rubber sheet 40 is attached to the retaining portion 31 in a state of being deformed into a U-shape so as to make the rubber domes 41 inwardly opposed to each other as illustrated in FIG. 4, and retained by the retaining portion 31 in a state of being bent along the arch-shaped inside surface of the retaining portion 31 as illustrated in FIG. 2.

As illustrated in FIG. 1, the rubber domes 41 of the rubber sheet 40 retained by the retaining portion 31 oppose to each other across the wall portion 12 formed at the casing 10.

At this time, an elastic force to return to the original shape (see FIG. 3) acts on the rubber sheet 40 bent along the inside surface of the retaining portion 31. Therefore, the rubber sheet 40 is pushed against the inside surface of the retaining portion 31, and thus the rubber sheet 40 is unlikely to be detached from the retaining portion 31.

The switch 1 configured as described above is operated, for example, as follows.

That is, when a user moves the operation portion 33 about the shaft portion 34 (axis X) via the design grip, the entire lever 20 moves about the shaft portion 34 (axis X).

At this time, one of the rubber domes 41 comes into contact with the wall portion 12, thereby giving a click feeling to the user.

Note that when the opposing direction of the rubber domes 41 and the protruding direction of the wall portion 12 are orthogonal to each other, an optimum click feeling can be given to the user.

At the same time, the contact portion 32 comes into contact with the detector switch 50, which means that the detector switch 50 is indirectly operated, whereby an operation according to the function of the detector switch 50 is executed.

According to the present embodiment, the following effects are obtained.

Since the casing 10 including the wall portion 12, the two rubber domes 41 that are provided so as to oppose to each other across the wall portion 12 and give a click feeling, and the lever main body 30 including the retaining portion 31 that retains the rubber domes 41 and the contact portion 32 that comes in contact with the detector switch 50 are provided, and the retaining portion 31 and the contact portion 32 are provided so as to be rotatable about the axis X with respect to the casing 10, the lever main body 30 can have a function of retaining the rubber domes 41 that give a click feeling to a user when the user operates the lever 20. Accordingly, a case for retaining the rubber domes 41 is not required, and cost reduction can be achieved. Further, since there is no case for retaining the rubber domes 41, the man-hours required for assembly can be reduced as compared with a switch having a separate case.

The inside surface of the retaining portion 31 has an arch shape across the wall portion 12, the two rubber domes 41 are integrally provided on the rubber sheet 40 having elasticity, and the rubber sheet 40 is retained by the retaining portion 31 in a state of being bent along the arch shape of the inside surface, and thus the rubber sheet 40 is pushed against the inside surface of the retaining portion 31 by the elasticity of the rubber sheet 40 and the rubber sheet 40 (rubber domes 41) is unlikely to be detached from the retaining portion 31.

When the opposing direction of the rubber domes 41 is substantially orthogonal to the protruding direction of the wall portion 12, stable operation of the lever 20 can be realized. In addition, an appropriate click feeling can be given to a user.

The lever main body 30 includes the operation portion 33 configured to rotate the retaining portion 31 and the contact portion 32 about the axis X, and the operation portion 33 extends to a side opposite to the retaining portion 31 with respect to the axis X and is provided so as to be offset in the direction of the axis X with respect to the retaining portion 31, and thus a space can be provided on a side opposite to the operation portion 33 with respect to the axis X. Accordingly, for example, by providing a light source in the space, a visual effect using the light source can be given to the operation portion 33.

In the lever main body 30, a projection 35 projecting in the direction of the axis X may be provided at a position below a vertex of the arch shape of the rubber sheet 40.

This can prevent the rubber sheet 40 from falling from the retaining portion 31.

The switch according to the embodiment described above is understood as follows, for example.

That is, a switch (1) according to a first aspect of the present disclosure includes: a casing (10) including a wall portion (12): two clicking members (41) that are provided so as to oppose to each other across the wall portion and give a click feeling: a lever main body (30) including a retaining portion (31) and a contact portion (32), the retaining portion being provided to be rotatable about an axis (X) with respect to the casing and configured to retain the clicking members, the contact portion being configured to come into contact with a detector switch (50).

According to the switch of the present aspect, the casing including the wall portion, the two clicking members that are provided so as to oppose to each other across the wall portion and give a click feeling, and the lever main body including the retaining portion that retains the clicking members and the contact portion that comes in contact with the detector switch are provided, and the retaining portion and the contact portion are provided so as to be rotatable about the axis with respect to the casing, and thus the lever main body can have a function of retaining the clicking members that give a click feeling to a user when the user operates the lever. Accordingly, a case for retaining the clicking members is not required, and cost reduction can be achieved. Further, since there is no case for retaining the clicking members, the man-hours required for assembly can be reduced as compared with a switch having a separate case.

As the clicking members, the rubber domes are exemplified.

A switch according to a second aspect of the present disclosure is the switch according to the first aspect, wherein an inside surface of the retaining portion is formed into an arch shape across the wall portion, the two clicking members are integrally provided on a sheet member (40) having an elasticity, and the sheet member is bent along the arch shape of the inside surface and retained by the retaining portion.

According to the switch of the present aspect, the inside surface of the retaining portion has an arch shape across the wall portion, the two clicking members are integrally provided on the sheet member having elasticity, and the sheet member is retained by the retaining portion in a state of being bent along the arch shape of the inside surface, and thus the sheet member is pushed against the inside surface of the retaining portion by the elasticity of the sheet member such that the sheet member (clicking members) is unlikely to be detached from the retaining portion.

A switch according to a third aspect of the present disclosure is the switch according to the second aspect, wherein the lever main body includes a projection (35) provided below a vertex of the arch shape of the sheet member retained by the retaining portion.

According to the switch of the present aspect, since the lever main body includes the projection provided below the vertex of the arch shape of the sheet member retained by the retaining portion, the sheet member can be prevented from falling off.

A switch according to a fourth aspect of the present disclosure is the switch according to any one the first to third aspects, wherein an opposing direction of the clicking members is substantially orthogonal to a protruding direction of the wall portion.

According to the switch of the present aspect, since the opposing direction of the clicking members is substantially orthogonal to the protruding direction of the wall portion, stable operation of the lever can be realized. In addition, an appropriate click feeling can be given to a user.

A switch according to a fifth aspect of the present disclosure is the switch according to any one of the first to fourth aspects, wherein the lever main body includes an operation portion (33) configured to rotate the retaining portion and the contact portion about the axis, and the operation portion extends on a side opposite to the retaining portion with respect to the axis and is provided so as to be offset in a direction of the axis with respect to the retaining portion.

According to the switch of the present aspect, the lever main body includes the operation portion that can rotate the retaining portion and the contact portion about the axis, and the operation portion extends on the side opposite to the retaining portion with respect to the axis and is provided so as to be offset in the direction of the axis with respect to the retaining portion, and thus a space can be provided on a side opposite to the operation portion with respect to the axis. Accordingly, for example, by providing a light source in the space, a visual effect using the light source can be given to the operation portion.

### REFERENCE SIGNS LIST

1 Switch
10 Casing
11 Accommodating space
12 Wall portion
20 Lever
30 Lever main body
31 Retaining portion
31a Leading end
31b Lightening portion
32 Contact portion
32a Leading end
33 Operation portion
34 Shaft portion
35 Projection
40 Rubber sheet
41 Rubber dome
42 Connection portion
50 Detector switch

1. A switch comprising:
a casing including a wall portion;
two clicking members provided so as to oppose to each other across the wall portion and configured to give a click feeling; and
a lever main body including a retaining portion and a contact portion, the retaining portion being provided to be rotatable about an axis with respect to the casing and configured to retain the clicking members, the contact portion being configured to come into contact with a detector switch.

2. The switch according to claim 1, wherein
an inside surface of the retaining portion is formed into an arch shape across the wall portion,
the two clicking members are integrally provided on a sheet member having an elasticity, and
the sheet member is bent along the arch shape of the inside surface and retained by the retaining portion.

3. The switch according to claim 2, wherein the lever main body includes a projection provided below a vertex of the arch shape of the sheet member retained by the retaining portion.

4. The switch according to claim 1, wherein an opposing direction of the clicking members is substantially orthogonal to a protruding direction of the wall portion.

5. The switch according to claim 1, wherein
the lever main body includes an operation portion configured to rotate the retaining portion and the contact portion about the axis, and
the operation portion extends on a side opposite to the retaining portion with respect to the axis and is provided so as to be offset in a direction of the axis with respect to the retaining portion.
